(19) United States
(12) Patent Application Publication
(10) Pub. No.: US 2019/0135271 A1
(43) Pub. Date: May 9, 2019

(54) Carbon Monoxide Detector for Automobiles

(71) Applicant: Luis Garcia, New York, NY (US)

(72) Inventor: Luis Garcia, New York, NY (US)

(21) Appl. No.: 16/114,169

(22) Filed: Aug. 27, 2018

Related U.S. Application Data
(60) Provisional application No. 62/550,667, filed on Aug. 27, 2017.

(51) Int. Cl. B60W 30/00; G08B 21/14; G07C 5/08; B60Q 9/00; B60W 10/30; B60W 10/06; B60W 50/14; F02D 35/00

(52) U.S. Cl. CPC B60W 30/00; B60W 2400/00; G07C 5/0833; G07C 5/0825; B60Q 9/00; B60W 10/30; B60W 10/06; B60W 50/14; F02D 35/00; B60W 2530/00; B60W 2710/06; B60W 2710/30; B60W 2050/143; B60W 2050/146; G08B 21/14

(57) ABSTRACT

A carbon monoxide detector for making automobiles, vans, SUVs, pickups, and heavy trucks safer by equipping them with an automatically functioning carbon-monoxide detector and early warning system whereupon the presence of a dangerous level of carbon monoxide in the interior of a vehicle will shut off the engine, lower the windows and issue a warning for occupants to leave the vehicle.

### CLAIM OF PRIORITY

This patent application claims priority under 35 USC 119 (e) (1) from U.S. Provisional Patent Application Ser. No. 62/550,667 filed Aug. 27, 207, of common inventorship herewith entitled, “CO Automobile Detector,” which is incorporated herein by reference as though the same were set forth in its entirety.

### FIELD OF THE INVENTION

The present invention pertains to the field of carbon monoxide detectors, and more specifically to the field of carbon monoxide detectors for making automobiles, vans, SUVs, pickups, and even heavy trucks safer, by equipping them with an automatically functioning carbon-monoxide detector and early-warning system.

### BACKGROUND OF THE INVENTION

America's love affair with the automobile is well over a hundred years old, and still going strong. Today's vehicles are lighter, sleeker, faster, more fuel-efficient, and equipped with more accessories than ever before. Recent recalls of various vehicles for problems with sticking gas-pedals, floor mats that can interfere with safe operation, and bolts in the steering system that can loosen over time suggests that vehicles might not be as safe as desired. And, in fact, from its earliest beginning, the automobile has been not only a blessing to families and individuals, but also a lethal danger. One moment of inattention; a few miles per hour too fast for a given stretch of road; an instant's lapse in reaction-time and the result is tragedy, shattered or extinguished lives, a welter of twisted metal and broken glass and blood on the highway. Driving a car, truck, SUV, or van is a life-or-death business, serious a matter as flying a plane and landing it safely. And when it comes to accidents, the two most common causes are “following too closely” and “traveling too fast for conditions.”

When behind the wheel, being in too much of a hurry, or following another car too closely, can not only get a ticket, it can get the drive and passengers killed. There are more than six million accidents each year in the United States. A person dies in a car accident every 12 minutes, and each year car crashes kill some 43,000 people and injure three times that number. Car crashes cost each American more than $1,000 a year; $164.2 billion is the total cost each year across the United States. Obviously, defensive driving is a key to survival such as seeing threats while there's time to avoid them; giving the car in front plenty of room; expecting other drivers to do the unexpected, and being ready to react to whatever they do. But safety also depends on a vehicle's safety equipment; not only the safety equipment, like brakes and seat-belts, in the car you're driving, but safety equipment (like brake lights) in the car you're following.

And when it comes to the safety equipment of the car you're driving, one critical element has so far been missing, i.e., a safe, effective means of determining whether some of your car's exhaust, in the form of deadly carbon-monoxide gas (CO) is seeping into the interior, putting yourself and your passengers at risk from this odorless, tasteless, “silent killer.” Nearly 500 people are killed each year by carbon-monoxide poisoning, and while most are killed in their homes, many of us fail to realize that our vehicle's exhaust system is a primary source of this toxic gas which puts you asleep before it kills you.

The prior art has put forth several designs for carbon monoxide detectors. Among these are:

U.S. Pat. No. 6,208,256 to Raymond Fleming provides an automobile carbon monoxide detection and control device that interfaces with various elements of a vehicle to allow for shutoff or control of a vehicle's motor or windows as a function of carbon monoxide level.

US Patent Application No. 2015/0057912 to Walt Joseph Ortmann provides a vehicle carbon monoxide detection system for a vehicle includes a vehicle internal combustion engine; a controller interfacing with the vehicle internal combustion engine; a carbon monoxide sensor interfacing with the controller, the carbon monoxide sensor adapted to detect a level of carbon monoxide. The controller is adapted to prevent and terminate operation of the vehicle internal combustion engine if the level of carbon monoxide detected by the carbon monoxide sensor exceeds a threshold carbon monoxide level. A vehicle and a vehicle carbon monoxide detection method are also disclosed.

U.S. Pat. No. 5,739,756 to Stuart Margulies provides a new carbon monoxide detector for motor vehicles for detecting dangerous levels of carbon monoxide within the passenger areas of motor vehicles. The inventive device includes a carbon monoxide detector mounted at the highest point within a passenger compartment of the vehicle, a visual indicating signal to visually signal a warning when dangerous levels of carbon monoxide are detected, and an audible signaling device to provide an audible signal when dangerous levels are detected.

None of these prior art references describe the present invention.

### SUMMARY OF THE INVENTION

It is an object of the present invention to providing a carbon monoxide detector for making automobiles, vans, SUVs, pickups, and even heavy trucks safer, by equipping them with an automatically functioning carbon-monoxide detector and early-warning system.

### BRIEF DESCRIPTION OF THE DRAWINGS

FIG. 1 is a schematic view illustrating a carbon monoxide detector, constructed in accordance with the present invention.

### DETAILED DESCRIPTION OF THE INVENTION

The present invention is a CO Automobile Detector incorporated into the design and manufacture of new motor vehicles, and/or developed as an add-on, aftermarket accessory that is designed to detect the presence of carbon-monoxide in a vehicle's interior, and to roll down the windows, and shut down the engine, in the event carbon-monoxide has been detected.

The CO Automobile Detector operates electronically, and is incorporated into the vehicle's wiring harness and electrical system. The CO Automobile Detector itself is situated within the vehicle's interior; and when carbon-monoxide levels reach a specific threshold, the CO Automobile Detector responds in three simultaneous ways: 1) The CO Automobile Detector will trip a switch that shuts down the CO-emitting engine, thus stopping CO gas at its source; 2) The CO Automobile Detector will immediately lower all (electrically operated) windows in the vehicle; and 3) The CO Automobile Detector will emit an audio-visual warning such as a flashing red or yellow dashboard light, along with a piercing alarm tone or perhaps a “verbal” warning: “Dangerous Carbon-Monoxide Detected! Exit the Vehicle Now!” At this point, until the engine has cooled and the carbon-monoxide level in the interior dropped to zero, the vehicle cannot be started.

The CO Automobile Detector will function automatically, powered by the battery when the vehicle is stationary, and powered by the electrical system when the vehicle is in motion. Once the Detector/Alarm sequence has occurred, the CO Automobile Detector resets to battery-powered mode, and indicate by the cessation of its audio-visual alarms when it was safe to get back into the vehicle. And, of course, any activation of the CO Automobile Detector provides a clear and compelling, life-or-death reason to get one's vehicle to a competent mechanic/technician as quickly as possible.

In an alternative embodiment, the CO Automobile Detector is configured to first issue its alarms and roll down the windows, then provide a predetermined interval of time, such as 20 to 30 seconds of further engine operation before shutdown. This allows freeway drivers, for example, a chance to reach the shoulder of the road before the engine is shut down.

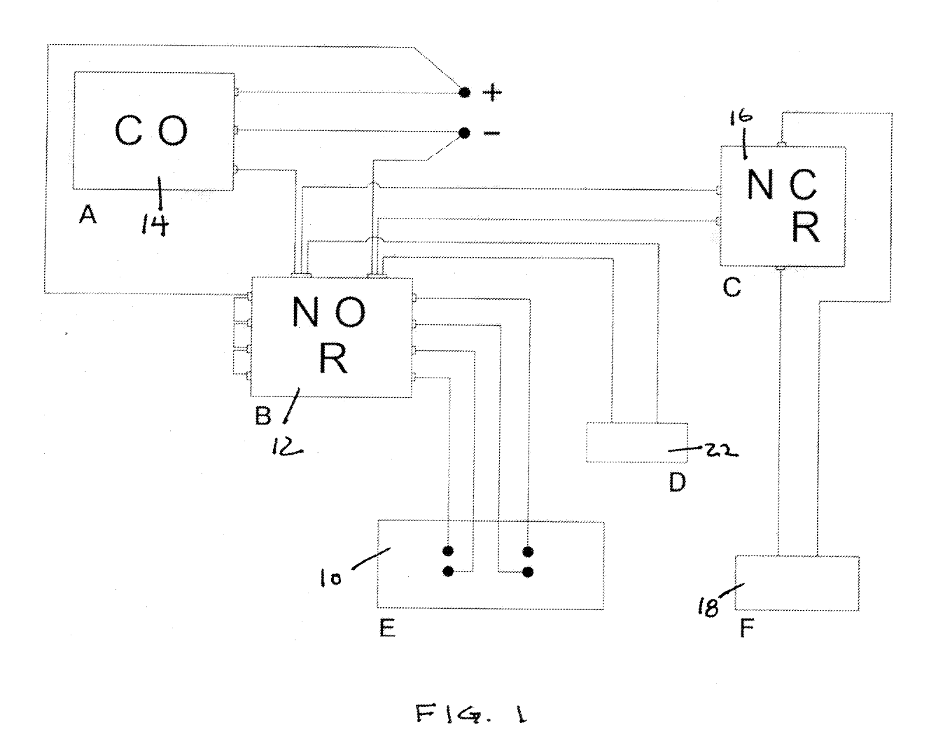

In the schematic flow diagram illustrated by FIG. 1, the sensor or detector 10 is situated in the interior of the vehicle, (not shown). Element 12 represents when no dangerous level of carbon monoxide is detected. Element 14 represents when carbon monoxide levels have reached a dangerous level. In this situation, an electrical circuit is broken, turning off the engine, represented by element 16, and further sending a signal to the windows, represented by element 22, and to initiate the alarm, represented by element 18.

No one knows how many vehicles have carbon-monoxide problems, and no one knows how many crashes, which appear to have occurred when the driver “fell asleep”, have been in fact caused by carbon-monoxide leaks into the vehicles' interior. Carbon-monoxide is tasteless, invisible, odorless, and lethal; and it is also a by-product of the burning of gasoline or diesel in an internal-combustion engine. The CO Automobile Detector not only detects the presence of this “silent killer”; it also shuts it down at its source, while opening all the windows of the vehicle to bring in lifesaving, fresh air. Clever in conception, thoughtful in design, and lifesaving in its function, the CO Automobile Detector whether incorporated into the design and manufacture of new vehicles and/or developed and produced as an add-on, aftermarket accessory will save lives. Thus, this essential safety system will find a wide and enthusiastic market among the motorists of America and the world.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A carbon monoxide detector for vehicles including automobiles, vans, SUVs, pickups, and heavy trucks safer, comprising an automatically functioning carbon-monoxide detector and early-warning system, wherein upon detection of carbon monoxide in the interior of a vehicle reaching a threshold level will shut off the engine, roll down windows and issue a warning.

2. The carbon monoxide detector of claim 1, wherein the detector is configured into the design and manufacture of new motor vehicles.

3. The carbon monoxide detector of claim 1, wherein the detector is configured as an add-on, aftermarket accessory for adapting to existing vehicles.

4. The carbon monoxide detector of claim 1, wherein the detector operates electronically, and is incorporated into the vehicle's wiring harness and electrical system.

5. The carbon monoxide detector of claim 1, wherein the warning comprises an audio-visual warning such as a flashing red or yellow or both dashboard light.

6. The carbon monoxide detector of claim 5, wherein the warning further comprises a piercing alarm tone.

7. The carbon monoxide detector of claim 5, wherein the warning further comprises a verbal warning such as: “Dangerous Carbon-Monoxide Detected! Exit the Vehicle Now!”

8. The carbon monoxide detector of claim 1, wherein the detector is configured to first issue its alarms and roll down the windows, then provide a predetermined interval of time before shutting down the engine.

9. The carbon monoxide detector of claim 1, which is powered by the battery when the vehicle is stationary, and powered by the electrical system when the vehicle is in motion.

10. The carbon monoxide detector of claim 1, wherein the detector resets to battery powered mode after the alarm has occurred and indicates by the cessation of its audio-visual alarms when it was safe to get back into the vehicle.
